(19) United States
(12) Patent Application Publication
(10) Pub. No.: US 2020/0244397 A1
(43) Pub. Date: Jul. 30, 2020

(54) STREAM IDENTIFIER LANE PROTECTION

(71) Applicant: Intel Corporation, Santa Clara, CA (US)

(72) Inventors: Venkatraman Iyer, Austin, TX (US); Mahesh Wagh, Portland, OR (US); Joon Teik HOR, Bayan Lepas (MY)

(21) Appl. No.: 15/761,409

(22) PCT Filed: Sep. 26, 2015
(86) PCT No.: PCT/US2015/052511

§ 371 Date: Mar. 19, 2018

(51) Int. Cl. H04L 1/00

(52) U.S. Cl. CPC H04L 1/0061; H04L 1/0072; H04L 1/0045; H04L 1/0041

(57) ABSTRACT

Data of different types are received on a plurality of data lanes of a physical link. Particular data is received on at least a portion of the plurality of data lanes, and a stream signal, corresponding to the particular data, is received on another of the lanes of the physical link, where the particular data is of a particular type different from other data previously sent on the plurality of data lanes. The stream signal includes a code component indicating that the particular data is of the particular type and a parity component for use in identifying whether a bit error is present in the stream signal.

### FIELD

This disclosure pertains to computing system, and in particular (but not exclusively) to point-to-point interconnects.

### BACKGROUND

Advances in semi-conductor processing and logic design have permitted an increase in the amount of logic that may be present on integrated circuit devices. As a corollary, computer system configurations have evolved from a single or multiple integrated circuits in a system to multiple cores, multiple hardware threads, and multiple logical processors present on individual integrated circuits, as well as other interfaces integrated within such processors. A processor or integrated circuit typically comprises a single physical processor die, where the processor die may include any number of cores, hardware threads, logical processors, interfaces, memory, controller hubs, etc.

As a result of the greater ability to fit more processing power in smaller packages, smaller computing devices have increased in popularity. Smartphones, tablets, ultrathin notebooks, and other user equipment have grown exponentially. However, these smaller devices are reliant on servers both for data storage and complex processing that exceeds the form factor. Consequently, the demand in the high-performance computing market (i.e. server space) has also increased. For instance, in modern servers, there is typically not only a single processor with multiple cores, but also multiple physical processors (also referred to as multiple sockets) to increase the computing power. But as the processing power grows along with the number of devices in a computing system, the communication between sockets and other devices becomes more critical.

In fact, interconnects have grown from more traditional multi-drop buses that primarily handled electrical communications to full blown interconnect architectures that facilitate fast communication. Unfortunately, as the demand for future processors to consume at even higher-rates corresponding demand is placed on the capabilities of existing interconnect architectures.

### BRIEF DESCRIPTION OF THE DRAWINGS

FIG. 1 illustrates an embodiment of a computing system including an interconnect architecture.

FIG. 2 illustrates an embodiment of a interconnect architecture including a layered stack.

FIG. 3 illustrates an embodiment of a request or packet to be generated or received within an interconnect architecture.

FIG. 4 illustrates an embodiment of a transmitter and receiver pair for an interconnect architecture.

FIG. 5 illustrates an embodiment of a multichip package.

FIG. 6 is a simplified block diagram of a multichip package link (MCPL).

FIG. 7 is a representation of example signaling on an example MCPL.

FIG. 8 is a simplified block diagram of an MCPL.

FIG. 9 is a representation of a portion of an example link state machine.

FIG. 10 is a representation of an example link state machine.

FIG. 11 is a representation of signaling to enter a low power state.

FIG. 12 is a block diagram illustrating an example implementation of an MCPL.

FIG. 13 is an example illustration of a stream identifier code sent on a stream lane of an example MCPL.

FIGS. 14A-14B are simplified flowcharts illustrating techniques for handling bit errors on a MCPL.

FIG. 15 illustrates an embodiment of a block for a computing system including multiple processors.

Like reference numbers and designations in the various drawings indicate like elements.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present invention. It will be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present invention.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or Ultrabooks™. And may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus', methods, and systems described herein are not limited to physical computing devices, but may also relate to software optimizations for energy conservation and efficiency. As will become readily apparent in the description below, the embodiments of methods, apparatus', and systems described herein (whether in reference to hardware, firmware, software, or a combination thereof) are vital to a ‘green technology’ future balanced with performance considerations.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it's a singular purpose of most fabrics to provide highest possible performance with maximum power saving. Below, a number of interconnects are discussed, which would potentially benefit from aspects of the invention described herein.

One interconnect fabric architecture includes the Peripheral Component Interconnect (PCI) Express (PCIe) architecture. A primary goal of PCIe is to enable components and devices from different vendors to inter-operate in an open architecture, spanning multiple market segments; Clients (Desktops and Mobile), Servers (Standard and Enterprise), and Embedded and Communication devices. PCI Express is a high performance, general purpose I/O interconnect defined for a wide variety of future computing and communication platforms. Some PCI attributes, such as its usage model, load-store architecture, and software interfaces, have been maintained through its revisions, whereas previous parallel bus implementations have been replaced by a highly scalable, fully serial interface. The more recent versions of PCI Express take advantage of advances in point-to-point interconnects, Switch-based technology, and packetized protocol to deliver new levels of performance and features. Power Management, Quality Of Service (QoS), Hot-Plug/Hot-Swap support, Data Integrity, and Error Handling are among some of the advanced features supported by PCI Express.

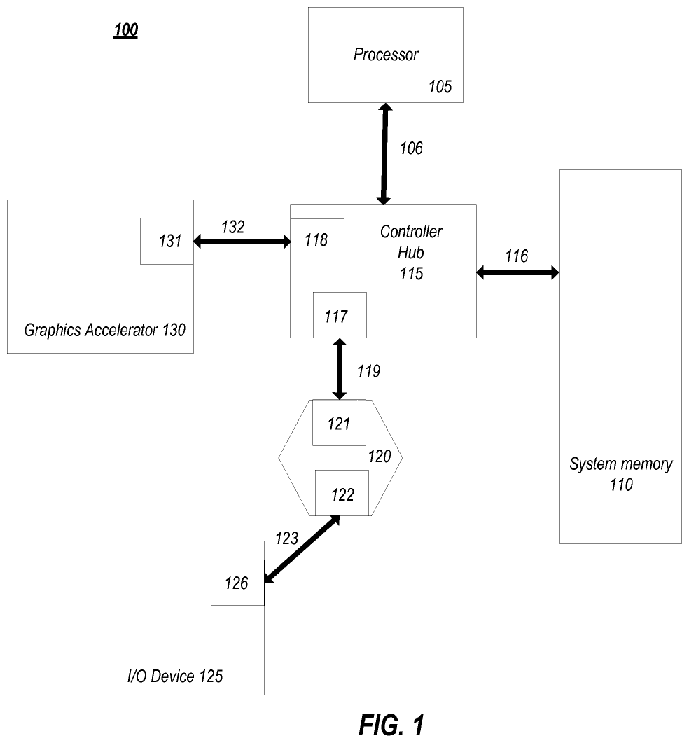

Referring to FIG. 1, an embodiment of a fabric composed of point-to-point Links that interconnect a set of components is illustrated. System 100 includes processor 105 and system memory 110 coupled to controller hub 115. Processor 105 includes any processing element, such as a microprocessor, a host processor, an embedded processor, a co-processor, or other processor. Processor 105 is coupled to controller hub 115 through front-side bus (FSB) 106. In one embodiment, FSB 106 is a serial point-to-point interconnect as described below. In another embodiment, link 106 includes a serial, differential interconnect architecture that is compliant with different interconnect standard. One or more components of the system 100 can be provided with logic to implement the features described herein.

System memory 110 includes any memory device, such as random access memory (RAM), non-volatile (NV) memory, or other memory accessible by devices in system 100. System memory 110 is coupled to controller hub 115 through memory interface 116. Examples of a memory interface include a double-data rate (DDR) memory interface, a dual-channel DDR memory interface, and a dynamic RAM (DRAM) memory interface.

In one embodiment, controller hub 115 is a root hub, root complex, or root controller in a Peripheral Component Interconnect Express (PCIe or PCIE) interconnection hierarchy. Examples of controller hub 115 include a chipset, a memory controller hub (MCH), a northbridge, an interconnect controller hub (ICH), a southbridge, and a root controller/hub. Often the term chipset refers to two physically separate controller hubs, i.e. a memory controller hub (MCH) coupled to an interconnect controller hub (ICH). Note that current systems often include the MCH integrated with processor 105, while controller 115 is to communicate with I/O devices, in a similar manner as described below. In some embodiments, peer-to-peer routing is optionally supported through root complex 115.

Here, controller hub 115 is coupled to switch/bridge 120 through serial link 119. Input/output modules 117 and 121, which may also be referred to as interfaces/ports 117 and 121, include/implement a layered protocol stack to provide communication between controller hub 115 and switch 120. In one embodiment, multiple devices are capable of being coupled to switch 120.

Switch/bridge 120 routes packets/messages from device 125 upstream, i.e. up a hierarchy towards a root complex, to controller hub 115 and downstream, i.e. down a hierarchy away from a root controller, from processor 105 or system memory 110 to device 125. Switch 120, in one embodiment, is referred to as a logical assembly of multiple virtual PCI-to-PCI bridge devices. Device 125 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices. Often in the PCIe vernacular, such as device, is referred to as an endpoint. Although not specifically shown, device 125 may include a PCIe to PCI/PCI-X bridge to support legacy or other version PCI devices. Endpoint devices in PCIe are often classified as legacy, PCIe, or root complex integrated endpoints.

Graphics accelerator 130 is also coupled to controller hub 115 through serial link 132. In one embodiment, graphics accelerator 130 is coupled to an MCH, which is coupled to an ICH. Switch 120, and accordingly I/O device 125, is then coupled to the ICH. I/O modules 131 and 118 are also to implement a layered protocol stack to communicate between graphics accelerator 130 and controller hub 115. Similar to the MCH discussion above, a graphics controller or the graphics accelerator 130 itself may be integrated in processor 105.

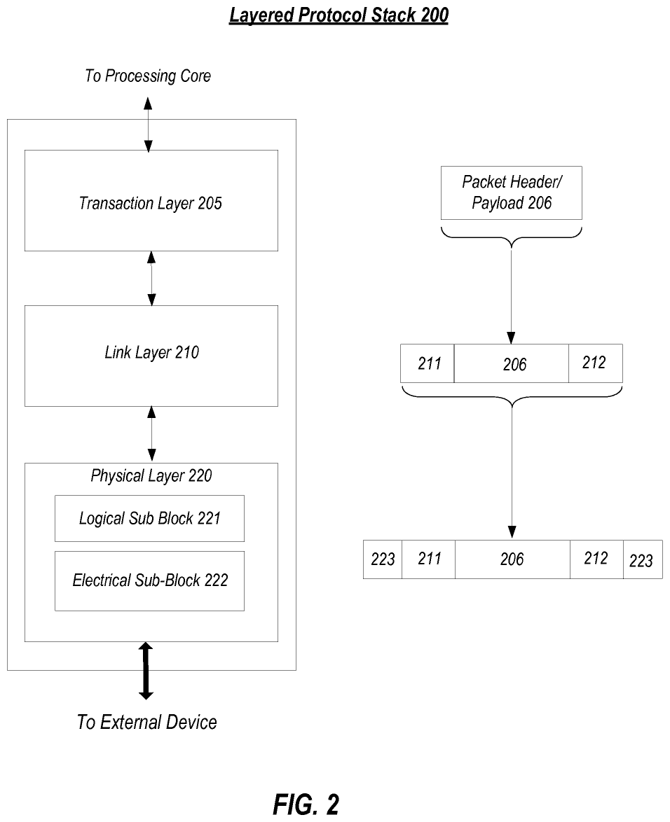

Turning to FIG. 2 an embodiment of a layered protocol stack is illustrated. Layered protocol stack 200 includes any form of a layered communication stack, such as a Quick Path Interconnect (QPI) stack, a PCie stack, a next generation high performance computing interconnect stack, or other layered stack. Although the discussion immediately below in reference to FIGS. 1-4 are in relation to a PCIe stack, the same concepts may be applied to other interconnect stacks. In one embodiment, protocol stack 200 is a PCIe protocol stack including transaction layer 205, link layer 210, and physical layer 220. An interface, such as interfaces 117, 118, 121, 122, 126, and 131 in FIG. 1, may be represented as communication protocol stack 200. Representation as a communication protocol stack may also be referred to as a module or interface implementing/including a protocol stack.

PCI Express uses packets to communicate information between components. Packets are formed in the Transaction Layer 205 and Data Link Layer 210 to carry the information from the transmitting component to the receiving component. As the transmitted packets flow through the other layers, they are extended with additional information necessary to handle packets at those layers. At the receiving side the reverse process occurs and packets get transformed from their Physical Layer 220 representation to the Data Link Layer 210 representation and finally (for Transaction Layer Packets) to the form that can be processed by the Transaction Layer 205 of the receiving device.

Transaction Layer

In one embodiment, transaction layer 205 is to provide an interface between a device's processing core and the interconnect architecture, such as data link layer 210 and physical layer 220. In this regard, a primary responsibility of the transaction layer 205 is the assembly and disassembly of packets (i.e., transaction layer packets, or TLPs). The translation layer 205 typically manages credit-base flow control for TLPs. PCIe implements split transactions, i.e. transactions with request and response separated by time, allowing a link to carry other traffic while the target device gathers data for the response.

In addition PCIe utilizes credit-based flow control. In this scheme, a device advertises an initial amount of credit for each of the receive buffers in Transaction Layer 205. An external device at the opposite end of the link, such as controller hub 115 in FIG. 1, counts the number of credits consumed by each TLP. A transaction may be transmitted if the transaction does not exceed a credit limit. Upon receiving a response an amount of credit is restored. An advantage of a credit scheme is that the latency of credit return does not affect performance, provided that the credit limit is not encountered.

In one embodiment, four transaction address spaces include a configuration address space, a memory address space, an input/output address space, and a message address space. Memory space transactions include one or more of read requests and write requests to transfer data to/from a memory-mapped location. In one embodiment, memory space transactions are capable of using two different address formats, e.g., a short address format, such as a 32-bit address, or a long address format, such as 64-bit address. Configuration space transactions are used to access configuration space of the PCIe devices. Transactions to the configuration space include read requests and write requests. Message space transactions (or, simply messages) are defined to support in-band communication between PCIe agents.

Therefore, in one embodiment, transaction layer 205 assembles packet header/payload 206. Format for current packet headers/payloads may be found in the PCIe specification at the PCIe specification website.

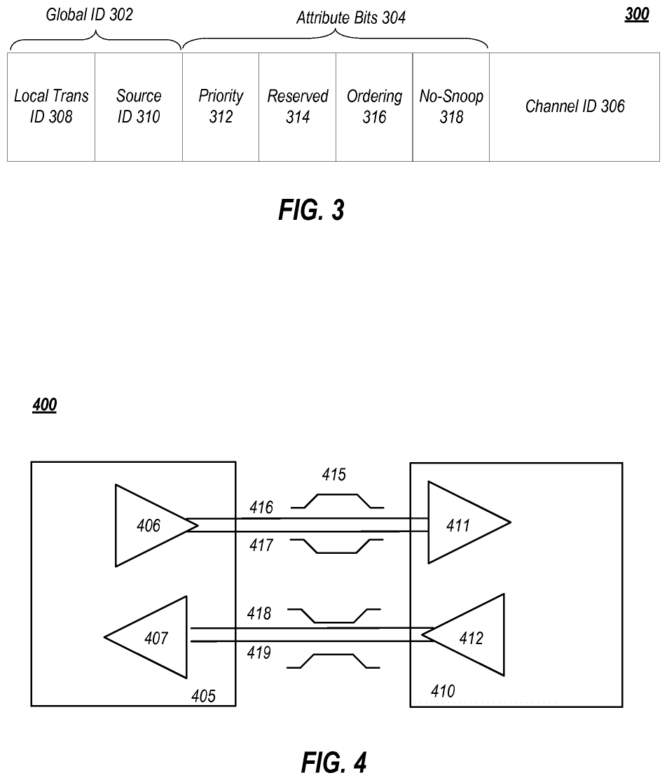

Quickly referring to FIG. 3, an embodiment of a PCIe transaction descriptor is illustrated. In one embodiment, transaction descriptor 300 is a mechanism for carrying transaction information. In this regard, transaction descriptor 300 supports identification of transactions in a system. Other potential uses include tracking modifications of default transaction ordering and association of transaction with channels.

Transaction descriptor 300 includes global identifier field 302, attributes field 304 and channel identifier field 306. In the illustrated example, global identifier field 302 is depicted comprising local transaction identifier field 308 and source identifier field 310. In one embodiment, global transaction identifier 302 is unique for all outstanding requests.

According to one implementation, local transaction identifier field 308 is a field generated by a requesting agent, and it is unique for all outstanding requests that require a completion for that requesting agent. Furthermore, in this example, source identifier 310 uniquely identifies the requestor agent within a PCIe hierarchy. Accordingly, together with source ID 310, local transaction identifier 308 field provides global identification of a transaction within a hierarchy domain.

Attributes field 304 specifies characteristics and relationships of the transaction. In this regard, attributes field 304 is potentially used to provide additional information that allows modification of the default handling of transactions. In one embodiment, attributes field 304 includes priority field 312, reserved field 314, ordering field 316, and no-snoop field 318. Here, priority sub-field 312 may be modified by an initiator to assign a priority to the transaction. Reserved attribute field 314 is left reserved for future, or vendor-defined usage. Possible usage models using priority or security attributes may be implemented using the reserved attribute field.

In this example, ordering attribute field 316 is used to supply optional information conveying the type of ordering that may modify default ordering rules. According to one example implementation, an ordering attribute of “0” denotes default ordering rules are to apply, wherein an ordering attribute of “1” denotes relaxed ordering, wherein writes can pass writes in the same direction, and read completions can pass writes in the same direction. Snoop attribute field 318 is utilized to determine if transactions are snooped. As shown, channel ID Field 306 identifies a channel that a transaction is associated with.

Link Layer

Link layer 210, also referred to as data link layer 210, acts as an intermediate stage between transaction layer 205 and the physical layer 220. In one embodiment, a responsibility of the data link layer 210 is providing a reliable mechanism for exchanging Transaction Layer Packets (TLPs) between two components a link. One side of the Data Link Layer 210 accepts TLPs assembled by the Transaction Layer 205, applies packet sequence identifier 211, i.e. an identification number or packet number, calculates and applies an error detection code, i.e. CRC 212, and submits the modified TLPs to the Physical Layer 220 for transmission across a physical to an external device.

Physical Layer

In one embodiment, physical layer 220 includes logical sub block 221 and electrical sub-block 222 to physically transmit a packet to an external device. Here, logical sub-block 221 is responsible for the “digital” functions of Physical Layer 221. In this regard, the logical sub-block includes a transmit section to prepare outgoing information for transmission by physical sub-block 222, and a receiver section to identify and prepare received information before passing it to the Link Layer 210.

Physical block 222 includes a transmitter and a receiver. The transmitter is supplied by logical sub-block 221 with symbols, which the transmitter serializes and transmits onto to an external device. The receiver is supplied with serialized symbols from an external device and transforms the received signals into a bit-stream. The bit-stream is de-serialized and supplied to logical sub-block 221. In one embodiment, an 8b/10b transmission code is employed, where ten-bit symbols are transmitted/received. Here, special symbols are used to frame a packet with frames 223. In addition, in one example, the receiver also provides a symbol clock recovered from the incoming serial stream.

As stated above, although transaction layer 205, link layer 210, and physical layer 220 are discussed in reference to a specific embodiment of a PCIe protocol stack, a layered protocol stack is not so limited. In fact, any layered protocol may be included/implemented. As an example, an port/interface that is represented as a layered protocol includes: (1) a first layer to assemble packets, i.e. a transaction layer; a second layer to sequence packets, i.e. a link layer; and a third layer to transmit the packets, i.e. a physical layer. As a specific example, a common standard interface (CSI) layered protocol is utilized.

Referring next to FIG. 4, an embodiment of a PCIe serial point to point fabric is illustrated. Although an embodiment of a PCIe serial point-to-point link is illustrated, a serial point-to-point link is not so limited, as it includes any transmission path for transmitting serial data. In the embodiment shown, a basic PCIe link includes two, low-voltage, differentially driven signal pairs: a transmit pair 406/411 and a receive pair 412/407. Accordingly, device 405 includes transmission logic 406 to transmit data to device 410 and receiving logic 407 to receive data from device 410. In other words, two transmitting paths, i.e. paths 416 and 417, and two receiving paths, i.e. paths 418 and 419, are included in a PCIe link.

A transmission path refers to any path for transmitting data, such as a transmission line, a copper line, an optical line, a wireless communication channel, an infrared communication link, or other communication path. A connection between two devices, such as device 405 and device 410, is referred to as a link, such as link 415. A link may support one lane—each lane representing a set of differential signal pairs (one pair for transmission, one pair for reception). To scale bandwidth, a link may aggregate multiple lanes denoted by xN, where N is any supported Link width, such as 1, 2, 4, 8, 12, 16, 32, 64, or wider.

A differential pair refers to two transmission paths, such as lines 416 and 417, to transmit differential signals. As an example, when line 416 toggles from a low voltage level to a high voltage level, i.e. a rising edge, line 417 drives from a high logic level to a low logic level, i.e. a falling edge. Differential signals potentially demonstrate better electrical characteristics, such as better signal integrity, i.e. cross-coupling, voltage overshoot/undershoot, ringing, etc. This allows for better timing window, which enables faster transmission frequencies.

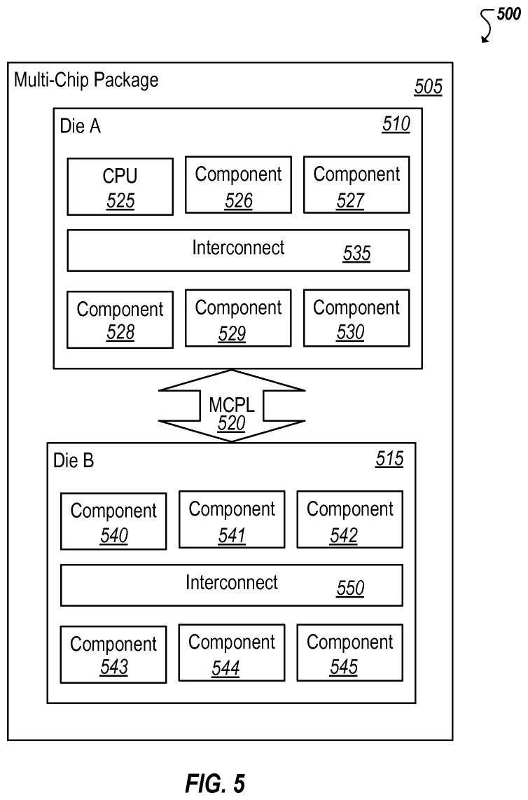

FIG. 5 is a simplified block diagram 500 illustrating an example multi-chip package 505 that includes two or more chips, or dies, (e.g., 510, 515) communicatively connected using an example multi-chip package link (MCPL) 520. While FIG. 5 illustrates an example of two (or more) dies that are interconnected using an example MCPL 520, it should be appreciated that the principles and features described herein regarding implementations of an MCPL can be applied to any interconnect or link connecting a die (e.g., 510) and other components, including connecting two or more dies (e.g., 510, 515), connecting a die (or chip) to another component off-die, connecting a die to another device or die off-package (e.g., 505), connecting die to a BGA package, implementation of a Patch on Interposer (POINT), among potentially other examples.

Generally, a multichip package (e.g., 505) can be an electronic package where multiple integrated circuits (ICs), semiconductor dies or other discrete components (e.g., 510, 515) are packaged onto a unifying substrate (e.g., silicon or other semiconductor substrate), facilitating the combined components' use as a single component (e.g., as though a larger IC). In some instances, the larger components (e.g., dies 510, 515) can themselves be IC systems, such as systems on chip (SoC), multiprocessor chips, or other components that include multiple components (e.g., 525-530 and 540-545) on the device, for instance, on a single die (e.g., 510, 515). Multichip packages 505 can provide flexibility for building complex and varied systems from potentially multiple discrete components and systems. For instance, each of dies 510, 515 may be manufactured or otherwise provided by two different entities, with the silicon substrate of the package 505 provided by yet a third entity, among many other examples. Further, dies and other components within a multichip package 505 can themselves include interconnect or other communication fabrics (e.g., 535, 550) providing the infrastructure for communication between components (e.g., 525-530 and 540-545) within the device (e.g., 510, 515 respectively). The various components and interconnects (e.g., 535, 550) may potentially support or use multiple different protocols. Further, communication between dies (e.g., 510, 515) can potentially include transactions between the various components on the dies over multiple different protocols. Designing mechanisms to provide communication between chips (or dies) on a multichip package can be challenging, with traditional solutions employing highly specialized, expensive, and package-specific solutions based on the specific combinations of components (and desired transactions) sought to be interconnected.

The examples, systems, algorithms, apparatus, logic, and features described within this Specification can address at least some of the issues identified above, including potentially many others not explicitly mentioned herein. For instance, in some implementations, a high bandwidth, low power, low latency interface can be provided to connect a host device (e.g., a CPU) or other device to a companion chip that sits in the same package as the host. Such a multichip package link (MCPL) can support multiple package options, multiple I/O protocols, as well as Reliability, Availability, and Serviceability (RAS) features. Further, the physical layer (PHY) can include an electrical layer and logic layer and can support longer channel lengths, including channel lengths up to, and in some cases exceeding, approximately 45 mm. In some implementations, an example MCPL can operate at high data rates, including data rates exceeding 8-10 Gb/s.

In one example implementation of an MCPL, a PHY electrical layer can improve upon traditional multi-channel interconnect solutions (e.g., multi-channel DRAM I/O), extending the data rate and channel configuration, for instance, by a number of features including, as examples, regulated mid-rail termination, low power active crosstalk cancellation, circuit redundancy, per bit duty cycle correction and deskew, line coding, and transmitter equalization, among potentially other examples.

In one example implementation of an MCPL, a PHY logical layer can be implemented that can further assist (e.g., electrical layer features) in extending the data rate and channel configuration while also enabling the interconnect to route multiple protocols across the electrical layer. Such implementations can provide and define a modular common physical layer that is protocol agnostic and architected to work with potentially any existing or future interconnect protocol.

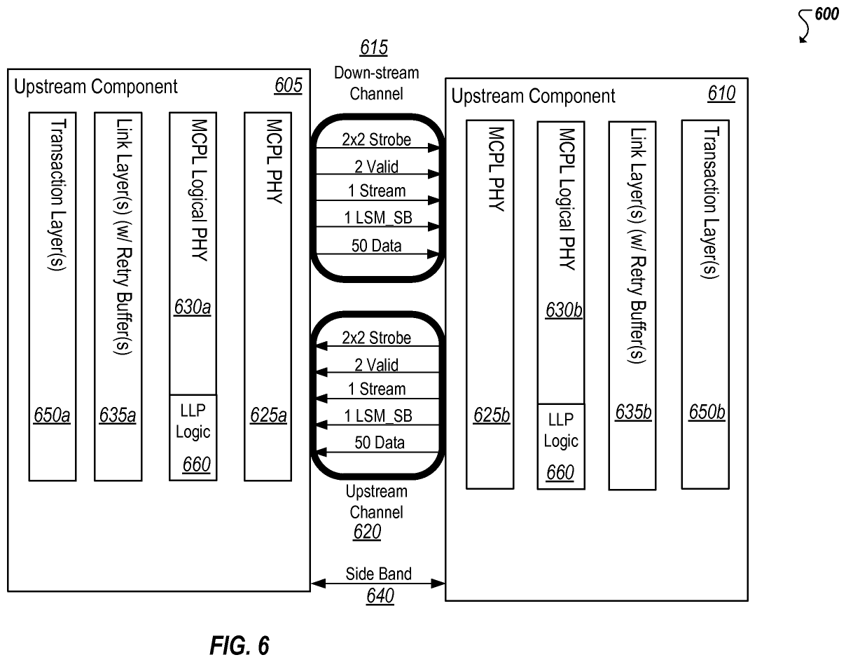

Turning to FIG. 6, a simplified block diagram 600 is shown representing at least a portion of a system including an example implementation of a multichip package link (MCPL). An MCPL can be implemented using physical electrical connections (e.g., wires implemented as lanes) connecting a first device 605 (e.g., a first die including one or more sub-components) with a second device 610 (e.g., a second die including one or more other sub-components). In the particular example shown in the high-level representation of diagram 600, all signals (in channels 615, 620) can be unidirectional and lanes can be provided for the data signals to have both an upstream and downstream data transfer. While the block diagram 600 of FIG. 6, refers to the first component 605 as the upstream component and the second component 610 as the downstream components, and physical lanes of the MCPL used in sending data as a downstream channel 615 and lanes used for receiving data (from component 610) as an upstream channel 620, it should be appreciated that the MCPL between devices 605, 610 can be used by each device to both send and receive data between the devices.

In one example implementation, an MCPL can provide a physical layer (PHY) including the electrical MCPL PHY 625a,b (or, collectively, 625) and executable logic implementing MCPL logical PHY 630a,b (or, collectively, 630). Electrical, or physical, PHY 625 can provide the physical connection over which data is communicated between devices 605, 610. Signal conditioning components and logic can be implemented in connection with the physical PHY 625 in order to establish high data rate and channel configuration capabilities of the link, which in some applications can involve tightly clustered physical connections at lengths of approximately 45 mm or more. The logical PHY 630 can include logic for facilitating clocking, link state management (e.g., for link layers 635a, 635b), and protocol multiplexing between potentially multiple, different protocols used for communications over the MCPL.

In one example implementation, physical PHY 625 can include, for each channel (e.g., 615, 620) a set of data lanes, over which in-band data can be sent. In this particular example, 50 data lanes are provided in each of the upstream and downstream channels 615, 620, although any other number of lanes can be used as permitted by the layout and power constraints, desired applications, device constraints, etc. Each channel can further include one or more dedicated lanes for a strobe, or clock, signal for the channel, one or more dedicated lanes for a valid signal for the channel, one or more dedicated lanes for a stream signal, and one or more dedicated lanes for a link state machine management or sideband signal. The physical PHY can further include a sideband link 640, which, in some examples, can be a bi-directional lower frequency control signal link used to coordinate state transitions and other attributes of the MCPL connecting devices 605, 610, among other examples.

In some implementations, in-band data (and other data) sent over the MCPL can be scrambled. In one example, the data can be scrambled, on each lane, using a pseudo random binary sequence (PRBS). In some implementations, the PRBS can be generated to be scrambled with outbound data using a linear feedback shift register (LFSR). A receiving device can unscramble the data to view the data in the clear, among other examples.

As noted above, multiple protocols can be supported using an implementation of MCPL. Indeed, multiple, independent transaction layers 650a, 650b can be provided at each device 605, 610. For instance, each device 605, 610 may support and utilize two or more protocols, such as PCI, PCIe, QPI, Intel In-Die Interconnect (IDI), among others. IDI is a coherent protocol used on-die to communicate between cores, Last Level Caches (LLCs), memory, graphics, and IO controllers. Other protocols can also be supported including Ethernet protocol, Infiniband protocols, and other PCIe fabric based protocols. The combination of the Logical PHY and physical PHY can also be used as a die-to-die interconnect to connect a SerDes PHY (PCIe, Ethernet, Infiniband or other high speed SerDes) on one Die to its upper layers that are implemented on the other die, among other examples.

Logical PHY 630 can support multiplexing between these multiple protocols on an MCPL. For instance, the dedicated stream lane can be used to assert an encoded stream signal that identifies which protocol is to apply to data sent substantially concurrently on the data lanes of the channel. Further, logical PHY 630 can be used to negotiate the various types of link state transitions that the various protocols may support or request. In some instances, LSM_SB signals sent over the channel's dedicated LSM_SB lane can be used, together with side band link 640 to communicate and negotiate link state transitions between the devices 605, 610. Further, link training, error detection, skew detection, de-skewing, and other functionality of traditional interconnects can be replaced or governed, in part using logical PHY 630. For instance, valid signals sent over one or more dedicated valid signal lanes in each channel can be used to signal link activity, detect skew, link errors, and realize other features, among other examples. In the particular example of FIG. 6, multiple valid lanes are provided per channel. For instance, data lanes within a channel can be bundled or clustered (physically and/or logically) and a valid lane can be provided for each cluster. Further, multiple strobe lanes can be provided, in some cases, also to provide a dedicated strobe signal for each cluster in a plurality of data lane clusters in a channel, among other examples.

As noted above, logical PHY 630 can be used to negotiate and manage link control signals sent between devices connected by the MCPL. In some implementations, logical PHY 630 can include link layer packet (LLP) generation logic 660 that can be used to send link layer control messages over the MCPL (i.e., in band). Such messages can be sent over data lanes of the channel, with the stream lane identifying that the data is link layer-to-link layer messaging, such as link layer control data, among other examples. Link layer messages enabled using LLP module 660 can assist in the negotiation and performance of link layer state transitioning, power management, loopback, disable, re-centering, scrambling, among other link layer features between the link layers 635a, 635b of devices 605, 610 respectively.

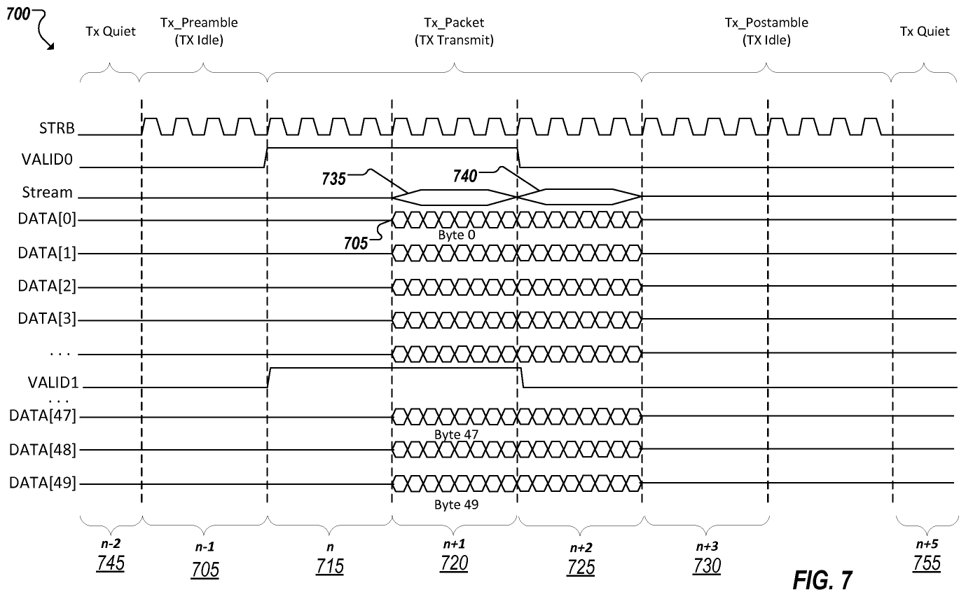

Turning to FIG. 7, a diagram 700 is shown representing example signaling using a set of lanes (e.g., 615, 620) in a particular channel of an example MCPL. In the example of FIG. 7, two clusters of twenty-five (25) data lanes are provided for fifty (50) total data lanes in the channel. A portion of the lanes are shown, while others (e.g., DATA[4-46] and a second strobe signal lane (STRB)) are omitted (e.g., as redundant signals) for convenience in illustrating the particular example. When the physical layer is in an active state (e.g., not powered off or in a low power mode (e.g., an L1 state)), strobe lanes (STRB) can be provided with a synchronous clock signal. In some implementations, data can be sent on both the rising and falling edges of the strobe. Each edge (or half clock cycle) can demarcate a unit interval (UI). Accordingly, in this example, a bit (e.g., 705) can be sent on each lane, allowing for a byte to be sent every 8UI. A byte time period 710 can be defined as 8UI, or the time for sending a byte on a single one of the data lanes (e.g., DATA[0-49]).

In some implementations, a valid signal, sent on one or more dedicated valid signal channels (e.g., VALID0, VALID1), can serve as a leading indicator for the receiving device to identify, when asserted (high), to the receiving device, or sink, that data is being sent from the sending device, or source, on data lanes (e.g., DATA[0-49]) during the following time period, such as a byte time period 710. Alternatively, when the valid signal is low, the source indicates to the sink that the sink will not be sending data on the data lanes during the following time period. Accordingly, when the sink logical PHY detects that the valid signal is not asserted (e.g., on lanes VALID0 and VALID1), the sink can disregard any data that is detected on the data lanes (e.g., DATA[0-49]) during the following time period. For instance, cross talk noise or other bits may appear on one or more of the data lanes when the source, in fact, is not sending any data. By virtue of a low, or non-asserted, valid signal during the previous time period (e.g., the previous byte time period), the sink can determine that the data lanes are to be disregarded during the following time period.

Data sent on each of the lanes of the MCPL can be strictly aligned to the strobe signal. A time period can be defined based on the strobe, such as a byte time period, and each of these periods can correspond to a defined window in which signals are to be sent on the data lanes (e.g., DATA[0-49]), the valid lanes (e.g., VALID1, VALID2), and stream lane (e.g., STREAM). Accordingly, alignment of these signals can enable identification that a valid signal in a previous time period window applies to data in the following time period window, and that a stream signal applies to data in the same time period window. The stream signal can be an encoded signal (e.g., 1 byte of data for a byte time period window), that is encoded to identify the protocol that applies to data being sent during the same time period window.

To illustrate, in the particular example of FIG. 7, a byte time period window is defined. A valid is asserted at a time period window n (715), before any data is injected on data lanes DATA[0-49]. At the following time period window n+1 (720) data is sent on at least some of the data lanes. In this case, data is sent on all fifty data lanes during n+1 (720). Because a valid was asserted for the duration of the preceding time period window n (715), the sink device can validate the data received on data lanes DATA[0-49] during time period window n+1 (720). Additionally, the leading nature of the valid signal during time period window n (715) allows the receiving device to prepare for the incoming data. Continuing with the example of FIG. 7, the valid signal remains asserted (on VALID1 and VALID2) during the duration of time period window n+1 (720), causing the sink device to expect the data sent over data lanes DATA[0-49] during time period window n+2 (725). If the valid signal were to remain asserted during time period window n+2 (725), the sink device could further expect to receive (and process) additional data sent during an immediately subsequent time period window n+3 (730). In the example of FIG. 7, however, the valid signal is de-asserted during the duration of time period window n+2 (725), indicating to the sink device that no data will be sent during time period window n+3 (730) and that any bits detected on data lanes DATA[0-49] should be disregarded during time period window n+3 (730).

As noted above, multiple valid lanes and strobe lanes can be maintained per channel. This can assist, among other advantages, with maintaining circuit simplicity and synchronization amid the clusters of relatively lengthy physical lanes connecting the two devices. In some implementations, a set of data lanes can be divided into clusters of data lanes. For instance, in the example of FIG. 7, data lanes DATA[0-49] can be divided into two twenty-five lane clusters and each cluster can have a dedicated valid and strobe lane. For instance, valid lane VALID1 can be associated with data lanes DATA[0-24] and valid lane VALID2 can be associated with data lanes DATA[25-49]. The signals on each “copy” of the valid and strobe lanes for each cluster can be identical.

As introduced above, data on stream lane STREAM can be used to indicate to the receiving logical PHY what protocol is to apply to corresponding data being sent on data lanes data lanes DATA[0-49]. In the example of FIG. 7, a stream signal is sent on STREAM during the same time period window as data on data lanes DATA[0-49] to indicate the protocol of the data on the data lanes. In alternative implementations, the stream signal can be sent during a preceding time period window, such as with corresponding valid signals, among other potential modifications. However, continuing with the example of FIG. 7, a stream signal 735 is sent during time period window n+1 (720) that is encoded to indicate the protocol (e.g., PCIe, PCI, IDI, QPI, etc.) that is to apply to the bits sent over data lanes DATA[0-49] during time period window n+1 (720). Similarly, another stream signal 740 can be sent during the subsequent time period window n+2 (725) to indicate the protocol that applies to the bits sent over data lanes DATA[0-49] during time period window n+2 (725), and so on. In some cases, such as the example of FIG. 7 (where both stream signals 735, 740 have the same encoding, binary FF), data in sequential time period windows (e.g., n+1 (720) and n+2 (725)) can belong to the same protocol. However, in other cases, data in sequential time period windows (e.g., n+1 (720) and n+2 (725)) can be from different transactions to which different protocols are to apply, and stream signals (e.g., 735, 740) can be encoded accordingly to identify the different protocols applying to the sequential bytes of data on the data lanes (e.g., DATA[0-49]), among other examples.

In some implementations, a low power or idle state can be defined for the MCPL. For instance, when neither device on the MCPL is sending data, the physical layer (electrical and logical) of MCPL can go to an idle or low power state. For instance, in the example of FIG. 7, at time period window n−2 (745), the MCPL is in a quiet or idle state and the strobe is disabled to save power. The MCPL can transition out of low-power or idle mode, awaking the strobe at time period window time period window n−1 (e.g., 705). The strobe can complete a transmission preamble (e.g., to assist in waking and synchronizing each of the lanes of the channel, as well as the sink device), beginning the strobe signal prior to any other signaling on the other non-strobe lanes. Following this time period window n−1 (705), the valid signal can be asserted at time period window n (715) to notify the sink that data is forthcoming in the following time period window n+1 (720), as discussed above.

The MCPL may re-enter a low power or idle state (e.g., an L1 state) following the detection of idle conditions on the valid lanes, data lanes, and/or other lanes of the MCPL channel. For instance, no signaling may be detected beginning at time period window n+3 (730) and going forward. Logic on either the source or sink device can initiate transition back into a low power state leading again (e.g., time period window n+5 (755)) to the strobe going idle in a power savings mode, among other examples and principles (including those discussed later herein).

Electrical characteristics of the physical PHY can include one or more of single-ended signaling, half-rate forwarded clocking, matching of interconnect channel as well as on-chip transport delay of transmitter (source) and receiver (sink), optimized electrostatic discharge (ESD) protection, pad capacitance, among other features. Further, an MCPL can be implemented to achieve higher data rate (e.g., approaching 16 Gb/s) and energy efficiency characteristics than traditional package I/O solutions.

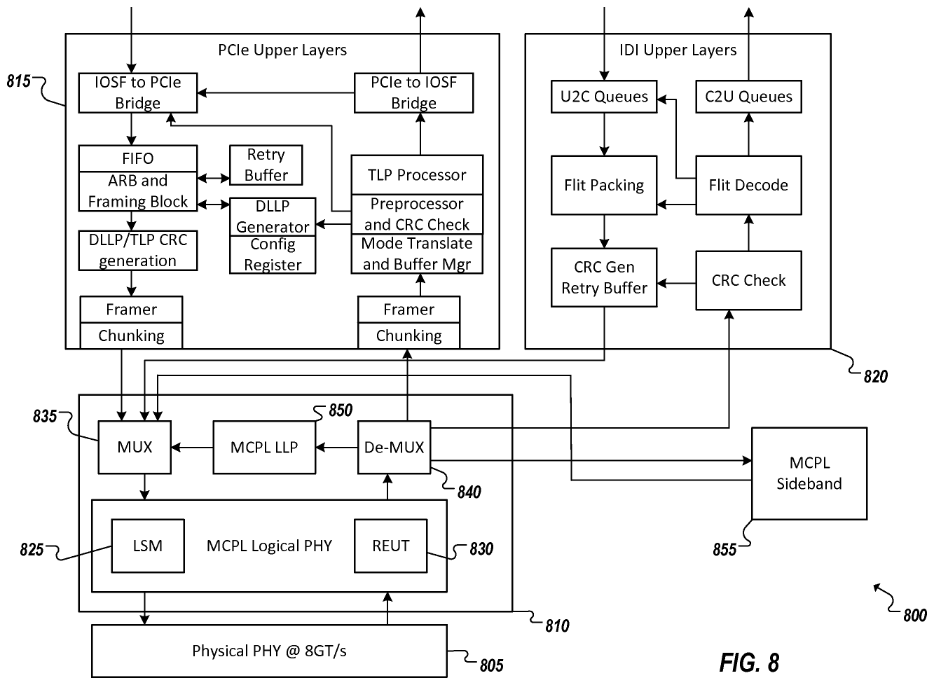

Turning to FIG. 8, a simplified block diagram 800 is shown illustrating an example logical PHY of an example MCPL. A physical PHY 805 can connect to a die that includes logical PHY 810 and additional logic supporting a link layer of the MCPL. The die, in this example, can further include logic to support multiple different protocols on the MCPL. For instance, in the example of FIG. 8, PCIe logic 815 can be provided as well as IDI logic 820, such that the dies can communicate using either PCIe or IDI over the same MCPL connecting the two dies, among potentially many other examples, including examples where more than two protocols or protocols other than PCIe and IDI are supported over the MCPL. Various protocols supported between the dies can offer varying levels of service and features.

Logical PHY 810 can include link state machine management logic 825 for negotiating link state transitions in connection with requests of upper layer logic of the die (e.g., received over PCIe or IDI). Logical PHY 810 can further include link testing and debug logic (e.g., 830) ion some implementations. As noted above, an example MCPL can support control signals that are sent between dies over the MCPL to facilitate protocol agnostic, high performance, and power efficiency features (among other example features) of the MCPL. For instance, logical PHY 810 can support the generation and sending, as well as the receiving and processing of valid signals, stream signals, and LSM sideband signals in connection with the sending and receiving of data over dedicated data lanes, such as described in examples above.

In some implementations, multiplexing (e.g., 835) and demultiplexing (e.g., 840) logic can be included in, or be otherwise accessible to, logical PHY 810. For instance, multiplexing logic (e.g., 835) can be used to identify data (e.g., embodied as packets, messages, etc.) that is to be sent out onto the MCPL. The multiplexing logic 835 can identify the protocol governing the data and generate a stream signal that is encoded to identify the protocol. For instance, in one example implementation, the stream signal can be encoded as a byte of two hexadecimal symbols (e.g., IDI: FFh; PCIe: F0h; LLP: AAh; sideband: 55h; etc.), and can be sent during the same window (e.g., a byte time period window) of the data governed by the identified protocol. Similarly, demultiplexing logic 840 can be employed to interpret incoming stream signals to decode the stream signal and identify the protocol that is to apply to data concurrently received with the stream signal on the data lanes. The demultiplexing logic 840 can then apply (or ensure) protocol-specific link layer handling and cause the data to be handled by the corresponding protocol logic (e.g., PCIe logic 815 or IDI logic 820).

Logical PHY 810 can further include link layer packet logic 850 that can be used to handle various link control functions, including power management tasks, loopback, disable, re-centering, scrambling, etc. LLP logic 850 can facilitate link layer-to-link layer messages over MCLP, among other functions. Data corresponding to the LLP signaling can be also be identified by a stream signal sent on a dedicated stream signal lane that is encoded to identify that the data lanes LLP data. Multiplexing and demultiplexing logic (e.g., 835, 840) can also be used to generate and interpret the stream signals corresponding to LLP traffic, as well as cause such traffic to be handled by the appropriate die logic (e.g., LLP logic 850). Likewise, as some implementations of an MCLP can include a dedicated sideband (e.g., sideband 855 and supporting logic), such as an asynchronous and/or lower frequency sideband channel, among other examples.

Logical PHY logic 810 can further include link state machine management logic that can generate and receive (and use) link state management messaging over a dedicated LSM sideband lane. For instance, an LSM sideband lane can be used to perform handshaking to advance link training state, exit out of power management states (e.g., an L1 state), among other potential examples. The LSM sideband signal can be an asynchronous signal, in that it is not aligned with the data, valid, and stream signals of the link, but instead corresponds to signaling state transitions and align the link state machine between the two die or chips connected by the link, among other examples. Providing a dedicated LSM sideband lane can, in some examples, allow for traditional squelch and received detect circuits of an analog front end (AFE) to be eliminated, among other example benefits.

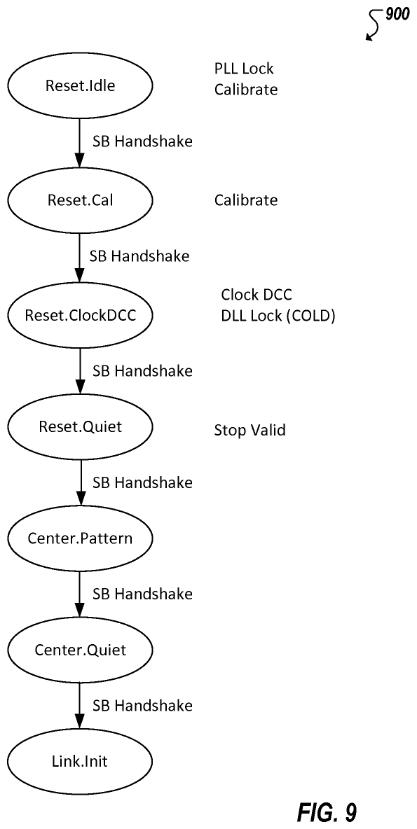

Turning to FIG. 9, a simplified link state machine transition diagram 900 is shown together with sideband handshaking utilized between the state transitions. For instance, a Reset.Idle state (e.g., where phase lock loop (PLL) lock calibration is performed) can transition, through a sideband handshake, to a Reset.Cal state (e.g., where the link is further calibrated). Reset.Cal can transition, through a sideband handshake, to a Reset.ClockDCC state (e.g., where duty cycle correction (DCC) and delay-locked looping (DLL) lock can be performed). An additional handshake can be performed to transition from Reset.ClockDCC to a Reset.Quiet state (e.g., to deassert the Valid signal). To assist in alignment of signaling on the lanes of the MCPL, the lanes can be centered through a Center.Pattern state.

In some implementations, during the Center.Pattern state, the transmitter can generate training patterns or other data. The receiver can condition its receiver circuitry to receive such training patterns, for instance, by setting the phase interpolator position and vref position and setting the comparator. The receiver can continuously compare the patterns received with expected patterns and store the result in a register. After one set of patterns are complete, the receiver can increment the phase interpolator setting keeping the vref the same. The test pattern generation and comparison process can continue and new compare results can be stored in the register with the procedure repeatedly stepping through all phase interpolator values and through all values of vref. The Center.Quiet state can be entered when the pattern generation and comparison process is all complete. Following the centering of the lanes through the Center.Pattern and Center Quiet link states, a sideband handshake (e.g., using an LSM sideband signal over the dedicated LSM sideband lane of the link) can be facilitated to transition to a Link.Init state to initialize the MCPL and enable sending of data on the MCPL.

As noted above, sideband handshakes can be used to facilitate link state machine transitions between dies or chips in a multi-chip package. For instance, signals on the LSM sideband lanes of an MCPL can be used to synchronize the state machine transitions across the die. For example, when the conditions to exit a state (e.g., Reset.Idle) are met, the side that met those conditions can assert, on its outbound LSM_SB lane, an LSM sideband signal and wait for the other remote die to reach the same condition and assert an LSM sideband signal on its LSM_SB lane. When both LSM_SB signals are asserted the link state machine of each respective die can transition to the next state (e.g., a Reset.Cal state). A minimum overlap time can be defined during which both LSM_SB signals should be kept asserted prior to transitioning state. Further, a minimum quiesce time can be defined after LSM_SB is de-asserted to allow for accurate turn-around detection. In some implementations, every link state machine transition can be conditioned on and facilitated by such LSM_SB handshakes.

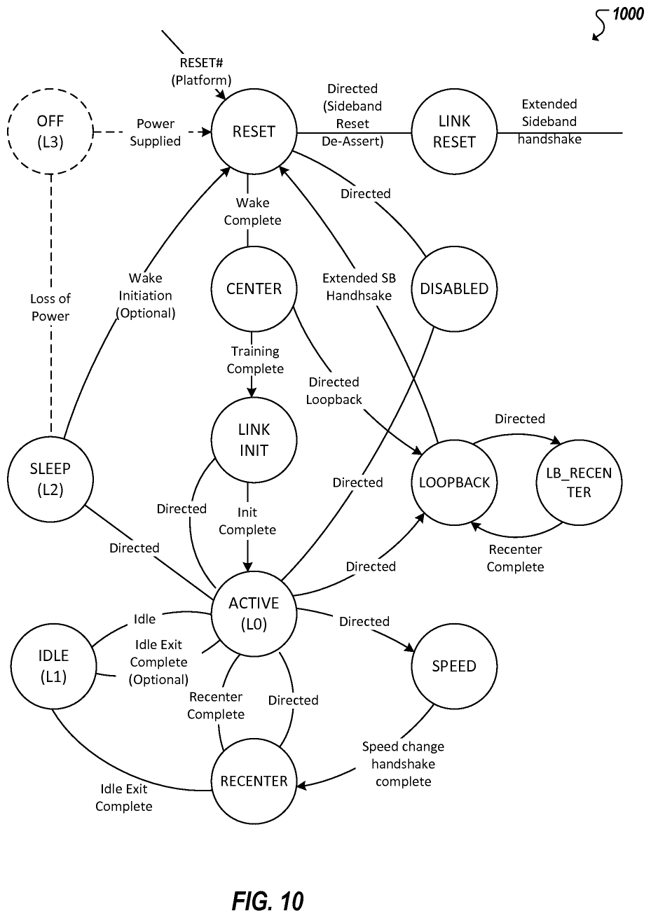

FIG. 10 is a more detailed link state machine diagram 1000, illustrating at least some of the additional link states and link state transitions that can be included in an example MCPL. In some implementations, an example link state machine can include, among the other states and state transitions illustrated in FIG. 10, a “Directed Loopback” transition can be provided to place the lanes of an MCPL into a digital loopback. For instance, the receiver lanes of an MCPL can be looped back to the transmitter lanes after the clock recovery circuits. An “LB_Recenter” state can also be provided in some instances, which can be used to align the data symbols. Additionally, as shown in FIG. 9, MCPL can support multiple link states, including an active L0 state and low power states, such as an L1 idle state, and L2 sleep state, among potentially other examples. As another example, configuration or centering states (e.g., CENTER) can be augmented or natively support reconfiguration of a link, while powered on, to allow lanes of the link to be re-assigned to route data around one or more lanes of the link determined to be faulty, or marginal, among other examples.

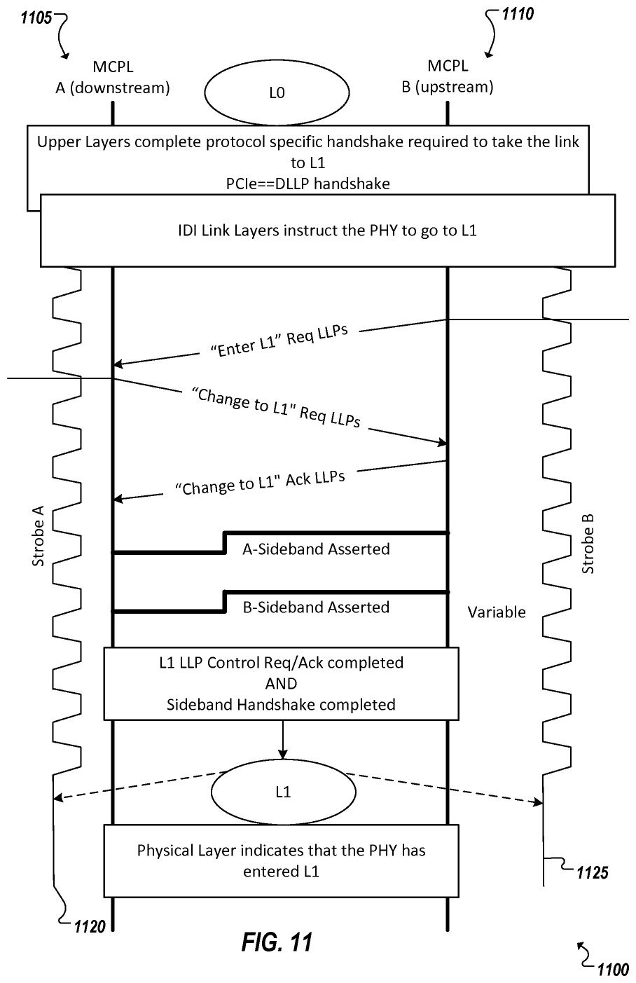

FIG. 11 is a simplified block diagram 1100 illustrating an example flow in a transition between an active state (e.g., L0) and a low-power, or idle, state (e.g., L1). In this particular example, a first device 1105 and a second device 1110 are communicatively coupled using an MCPL. While in the active state, data is transmitted over the lanes of the MCPL (e.g., DATA, VALID, STREAM, etc.). Link layer packets (LLPs) can be communicated over the lanes (e.g., data lanes, with the stream signal indicating that the data is LLP data), to assist in facilitating link state transitions. For instance, LLPs can be sent between the first and second devices 1105, 1110 to negotiate entry from L0 into L1. For instance, upper layer protocols supported by the MCPL can communicate that entry into L1 (or another state) is desired and the upper layer protocols can cause LLPs to be sent over the MCPL to facilitate a link layer handshake to cause the physical layer to enter L1. For instance, FIG. 11 shows at least a portion of LLPs sent including an “Enter L1” request LLP sent from the second (upstream) device 1110 to the first (downstream) device 1105. In some implementations, and upper level protocols, the downstream port does not initiate the entry into L1. The receiving first device 1105 can send a “Change to L1” request LLP in response, which the second device 1110 can acknowledge through a “Change to L1” acknowledgement (ACK) LLP, among other examples. Upon detecting completion of the handshake, the logical PHY can cause a sideband signal to be asserted on a dedicated sideband link to acknowledge that the ACK was received and that the device (e.g., 1105) is ready for and expecting entry into L1. For instance, the first device 1105 can assert a sideband signal 1115 sent to the second device 1110 to confirm receipt of the final ACK in the link layer handshake. Additionally, the second device 1110 can also assert a sideband signal in response to sideband signal 1115 to notify the first device 1105 of the first device's sideband ACK 1105. With the link layer control and sideband handshakes completed, the MCPL PHY can be transitioned into the L1 state causing all lanes of the MCPL to be put into idle power savings mode, including respective MCPL strobes of the 1120, 1125 of the devices 1105, 1110. The L1 can be exited upon upper level layer logic of one of the first and second devices 1105, 1110 requesting re-entry into L0, for instance, in response to detecting data to be sent to the other device over the MCPL.

As noted above, in some implementations, an MCPL can facilitate communication between two devices supporting potentially multiple different protocols, and the MCPL can facilitate communications according to potentially any one of the multiple protocols over the lanes of the MCPL. Facilitating multiple protocols, however, can complicate entry and reentry into at least some link states. For instance, while some traditional interconnects have a single upper layer protocol assuming the role of master in state transitions, an implementation of MCPL with multiple different protocols effectively involves multiple masters. As an example, as shown in FIG. 11, each of PCIe and IDI can be supported between two devices 1105, 1110 over an implementation of an MCPL. For instance, placing the physical layer into an idle or low power state may be conditioned on permission first being obtained from each of the supported protocols (e.g., both PCIe and IDI).

In some instances, entry into L1 (or another state) may be requested by only one of the multiple, supported protocols supported for an implementation of an MCPL. While there may be a likelihood that the other protocols will likewise request entry into the same state (e.g., based on identifying similar conditions (e.g., little or no traffic) on the MCPL), the logical PHY can wait until permission or instructions are received from each upper layer protocol before actually facilitating the state transition. The logical PHY can track which upper layer protocols have requested the state change (e.g., performed a corresponding handshake) and trigger the state transition upon identifying that each of the protocols have requested the particular state change, such as a transition from L0 to L1 or another transition that would affect or interfere with other protocols' communications. In some implementations, protocols can be blind as to their at least partial dependence on other protocols in the system. Further, in some instances, a protocol may expect a response (e.g., from the PHY) to a request to enter a particular state, such as a confirmation or rejection of the requested state transition. Accordingly, in such instances, while waiting for permission from other supported protocols for entry into an idle link state, the logical PHY can generate synthetic responses to a request to enter the idle state to “trick” the requesting upper layer protocol into believing that a particular state has been entered (when, in reality, the lanes are still active, at least until the other protocols also request entry into the idle state). Among other potential advantages, this can simplify coordinating entry into the low power state between multiple protocols, among other examples.

Implementations of a logical PHY can include error detection, error reporting, and error handling logic. In some implementations, a logical PHY of an example MCPL can include logic to detect PHY layer de-framing errors (e.g., on the valid and stream lanes), sideband errors (e.g., relating to LSM state transitions), errors in LLPs (e.g., that are critical to LSM state transitions), among other examples. Some error detection/resolution can be delegated to upper layer logic, such as PCIe logic adapted to detect PCIe-specific errors, or to system management software, among other examples. In some implementations, error detection and handling mechanisms can be provided, such as cyclic redundancy check (CRC), retry buffers, among other potential examples, to assist in bit error detection on an MCPL. Further, error detection logic, whether implemented in management software or the logic PHY, can determine that specific lanes are faulty, or marginal, based on determining lane-specific bit errors on a link.

An MCPL port can consists of a large number of lanes (e.g., 100 lanes or more) operating at very high speeds (e.g., 8 Gbs). For instance, an MCPL port can include 80 or more data lanes in each direction (e.g., 160+ total lanes). In some instances, an error correction code can be provided in flits sent over the data lanes to allow bit errors to be detected in data sent over the data lanes. In one particular example, a CRC can be included in the flit or in unused data lanes of the MCPL. For instance, a 16-bit CRC polynomial can be selected such that a CRC syndrome generated from the CRC can be used to identify specific bit errors, which can then be mapped to specific lanes of a link to allow marginal data lanes to be identified in the MCPL. In one example, syndrome properties of a 0x1f053 16-bit polynomial calculation can be used to identify bad lanes.

Hardware and/or software utilized to implement an MCPL can further provide functionality for identifying and resolving bit errors appearing on the dedicated stream identifier lane (e.g., “STREAM”) of the MCPL. Bit errors in a stream identifier sent on the stream lane can be particularly problematic as the bit errors can cause the type or protocol of corresponding data sent on data lanes of the MCPL to be incorrectly interpreted and improperly processed, leading to link errors and latency in the link.

As noted above, MCPL can time multiplex multiple link layer and physical layer traffic streams of potentially multiple different protocols. The stream (or stream_id) lane of MCPL can be used to identify the stream origin (and destination). While the flit or packet streams from the link layer sent on the data lanes are protected by an error correction code, such as CRC, the stream lane may not protected by the link layer CRC since the stream_id is used (e.g., inserted, checked) in the PHY layer to route the streams from/to the link layer. In some implementations, to mitigate against stream lane bit errors disrupting the MCPL, stream ID codes can be selected that can still be correctly interpreted despite a bit error. For instance, stream ID codes can be defined to each of a set of multiple different data types or protocols, such that the set of stream ID codes are selected to have a Hamming distance (e.g., HD=4) and low frequency (e.g., 0f). Such implementations also send the stream ID codes unscrambled (e.g., so as not to “undo” the provision of the high Hamming distance, low frequency, etc.). However, such solutions can be limited in their utility. For instance, a high Hamming distance, low frequency stream ID code would result in a relatively limited number of codes, especially if it is desired that each of the codes is balanced (e.g., equal numbers of 1's and 0's over a span of time). Accordingly, the number of different stream IDs and corresponding data types can be unduly limited. For instance, for an unscrambled 8-bit stream ID with HD=4, only four different stream ID codes are possible with only two that are DC-balanced.

Errors in stream ID codes sent on an MCPL stream lane can be further problematic when the errors cause timeouts and otherwise impact performance. For instance, detecting a stream ID error can result in the entire stream being blocked or having the data dropped. At the higher bandwidths of MCPL, dropping a flit of data or other portion of a stream can results in loss of flits/packets at the link layer, which can lead to timeouts (e.g., rather than retries). Waiting for a timeout can create backpressure further negatively impacting performance. The effect on performance can be significant since stream errors may not be infrequent at the higher speeds of MCPL (e.g., with mean time between errors (MTBE) between 1-3 hours at a bit error rate (BER) of 10e14). Also, since multiple streams are interleaved in MCPL, stream lane noise may stradle multiple streams thereby amplifying the performance impact. Given these complications, a stream ID bit error, in some implementations, can cause an automatic re-centering of the entire MCPL. However, re-centering can be an expensive process, from a performance perspective, taking multiple microseconds (e.g., 20 μs) during which time the link is unavailable to link layer traffic. The performance of threads not timing out may also be impacted.

In some implementations, a stream ID format can be utilized that allows for error detection and correction of most bit errors occurring on the stream lane of an MCPL. Such bit errors can be identified and correctly quickly and without impacting the performance of the link. Further, the resulting occurrence of bit errors that cannot be resolved automatically while the MCPL is active are statistically very rare (e.g., yearly or multi-yearly), limiting instances where a stream ID error causes a re-centering, reconfiguration, time-out, etc. In one particular implementations, the improved stream ID format can be implemented as a single error correcting, double error detecting (SECDED) code word that is transmitted on the stream lane similar to data transmitted on a data lane.

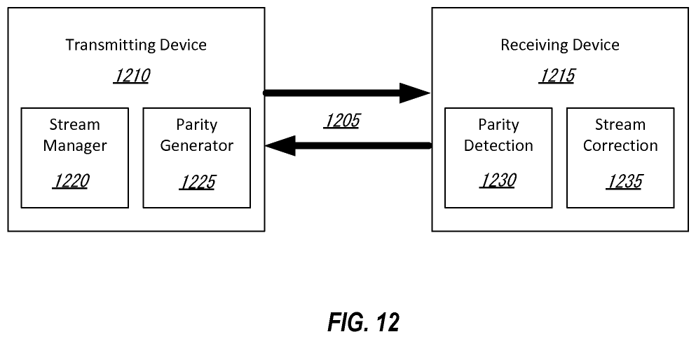

Turning to FIG. 12, a simplified block diagram 1200 is shown representing components implemented in hardware and/or software that can be provided, in some instances, to detect bit errors in stream ID codes sent over a stream lane of an MCPL 1205. For example, a first device 1210 can be coupled to a second device 1215 over the MCPL 1205. The first device 1210, in this example, can be a transmitting (Tx) device in a particular transaction (or instance) and send data to the second, receiving (Rx) device 1215 over the MCPL 1205. (It should be appreciated that in other instances, device 1215 can send data as the transmitting device over a MCPL to device 1210, among other examples.) The first device 1210 can include logic, such as a stream manager 1220, configured to generate stream IDs in connection with data to be sent on data lanes of the MCPL. For instance, a controller can indicate or schedule data of varying types over the time-multiplexed MCPL channel. The stream manager 1220 can identify the type of an upcoming window of data and identify the corresponding stream ID code of the type of data. The stream manager 1220 can generate the stream ID code and send it on the stream lane to correlate with its corresponding data, sent on the data lanes. In one example, the stream ID can incorporate parity (or check) bits generated by a parity generator 1225. The parity bits can be included in the stream ID. In one example, some of the stream ID bits can be code bits, used to identify the corresponding type of data, while the remaining stream ID bits are parity bits based on the value of the code bits.

A receiving device 1215 can receive a stream ID code generated by the transmitting device 1210 in connection with the sending of a corresponding type of data in a window of the MCPL 1205. The receiving device 1215 can include parity detection logic 1230 to read the code and parity values included in the stream ID code to determine whether bit errors are present in the stream ID. The code and parity values can be selected such that the receiving device can readily identify which bits of the stream ID code have errors and cause these bits to be flipped to correct the stream ID, for instance, using stream correction logic 1235 of the receiving device. The parity detection 1230 and stream correction 1235 can occur in advance of the corresponding data being processed at the receiving device 1215, allowing any bit errors present in the stream ID code to be identified and corrected such that the stream ID code (and its corresponding data) are properly processed at the receiver.

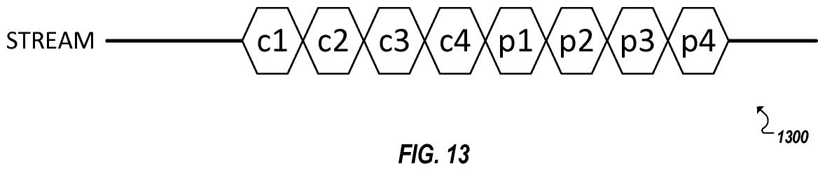

Turning to FIG. 13, a representation of an example stream ID code 1305 is presented to be sent on a stream lane of an MCPL. The length of a stream ID code can correspond to the length (e.g., in unit intervals (UIs)) of the window of data to which the stream ID code applied (and is to be sent). For instance, the example shown in FIG. 13 can correspond to an implementation utilizing an 8UI MCPL window. The stream ID code, in some implementations, can be a SECDED-based code. In the example of FIG. 13, the stream ID code 1305 is an 8,4 SECDED code used to protect a 4-bit code word (c1, c2, c3, c4) with four bits of parity (p1, p2, p3, p4). In this particular example, the 4-bit code word can allow sixteen possible stream IDs corresponding to potentially sixteen different types or formats of data and/or data compliant with sixteen different protocols to be sent over the same MCPL. In one example, the stream encoding can be SECDED codes with code/parity in the more/less significant hexadecimal digit. Further, of the sixteen potential codes, eight (e.g., 00, 33, 55, 66, 99, aa, cc, ff) also provide a good Hamming distance (HD=4). Code can be pre-assigned to corresponding types of data. As the system matures, it is possible to add types of data, resulting in the assignment of these added data types to one of the remaining available stream ID codes. In one example, codes with a good Hamming distance can be assigned to data stream types ahead of any available stream ID codes with less desirable Hamming distance.

In one illustrative example, a SECDED stream ID code can include parity bits p1, p2, p3, p4 generated from the binary values of the code bits c1, c2, c3, c4. For instance, the binary values of the parity bits can be calculated according to:

p1=c2+c3+c4

p2=c1+c3+c4

p3=c1+c2+c4

p4=c1+c2+c3+c4+p1+p2+p3=c1+c2+c3

Where the “+” operator signifies a logical exclusive OR (XOR) operation. (For instance, p1=c2+c3+c4=c2 XOR c3 XOR c4.) The transmitting device can identify the appropriate stream ID (c1c2c3c4) for the data and calculate the corresponding parity value (p1p2p3p4), concatenating the stream ID with the calculated parity value to generate the stream ID Hamming code word c1c2c3c4p1p2p3p4. The generated stream ID code can then be sent to a receiving device over the stream lane of the MCPL.

Upon receiving the stream ID code (c1c2c3c4p1p2p3p4), the receiver can generate a set of receive codes r1, r2, r3, r4, according to the following:

r1=c2+c3+c4+p1

r2=c1+c3+c4+p2

r3=c1+c2+c4+p3

r4=c1+c2+c3+c4+p1+p2+p3+p4

where the “+” operator signifies an XOR operation. From the receive codes, the receiving device can further determine fix locations f1, f2, f3, f4, according to the following:

f1=(!r1)& r2& r3& r4

f2=r1&(!r2)& r3& r4

f3=r1& r2&(!r3)& r4

f4=r1& r2& r3& r4

where the “&” operator signifies a logical AND operation, and the “!” operator signifies a logical negation, or NOT, operation. Each fix location (f1, f2, f3, f4) can identify, for a corresponding one of the code bits (c1, c2, c3, c4), whether the code bit has an error and should be fixed. For instance, if the value of f1=“1”, then the received code bit c1 should be fixed (i.e., the received binary value of c1 should be inverted). Thus, the fix values (f1, f2, f3, f4) can be applied to the received code bits (c1, c2, c3, c4) to generate a recovered/corrected code word d1d2d3d4 that matches the value of c1c2c3c4 as originally generated by the transmitting device. For instance, the recovered/corrected code word d1d2d3d4 can be generated according to:

d1=c1+f1

d2=c2+f2

d3=c3+f3

d4=c4+f4

where the values of c1, c2, c3, c4 are the values as received by the receiving device (i.e., not necessarily equal to the values originally generated by the transmitting device (due to bit errors)), and the “+” operator signifies an XOR operation.

In some implementations, the recovered/corrected code word d1d2d3d4 can be generated each time a stream ID code (c1c2c3c4p1p2p3p4) is received and can be adopted as the code word for identifying a corresponding data type and processing corresponding data (received over corresponding MCPL data lanes) accordingly. In addition to generating and utilizing a recovered/corrected code word d1d2d3d4, the receiver can additional determine, generally, whether (any code bit of) the received stream ID (c1c2c3c4) included a double error. For instance, if

(!r4)&(r1+r2+r3)=“1”,

then the receiving device can detect a double error in the stream ID. If such an error is detected, an error can be flagged and reported to system management software and/or a register. Additionally, some of the stream ID values can be defined as reserved/unused/unassigned. If the final code (e.g., d1d2d3d4) equals one of these unused or reserved values, the receiving device can also flag an error involving the stream lane (and supporting Tx and Rx logic) of the MCLP.

Calculations similar to those described in the examples above can be facilitated through logic implemented in hardware and/or software of the devices. Further, such calculations can be completed, and the stream ID corrected/verified, without adding substantive latency to the pipeline. Additionally, in some implementations, only a relatively small set of stream IDs may be needed to identify the set of protocols and/or data types to be supported on a particular implementation of an MCPL. If only a small number of codes are used, stronger stream ID codes can be adopted to correct and more reliably detect even more errors. For instance, for a set of four codes, 8 bit code words with HD=5 could be used, among other examples.

Utilizing a SECDED-based stream ID code can enable the ability to scramble the stream lanes, as with other lanes of the MCPL. This can assist in addressing noise reduction, crosstalk, electro-migration, and other issues that can likewise affect the stream lane of the MCPL. In instances where the stream lane is scrambled, the stream lane can be additionally centered and re-centered along with other data lanes, among other example advantages.

It should be appreciated that the specific examples illustrated above are provided as non-limiting examples of the application of the more general principles described herein. For instance, alternative implementations can apply similar principles. For instance, in some alternatives, a stream ID code of greater or less than 8 bits can be utilized. Additionally, technologies and interconnects other than an implementation of MCPL can utilize the principles described herein, among other examples.

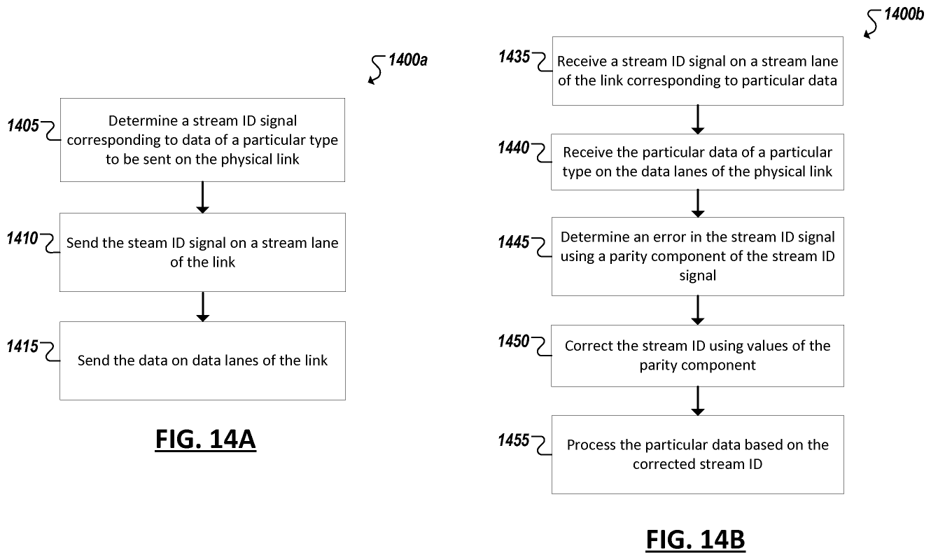

FIGS. 14A-14B show flowcharts 1400a-b illustrating example techniques for detecting and remedying bit errors in an MCPL. In the example of FIG. 14A, a stream ID can be determined 1405 for particular data of a particular one of a plurality of types to be sent on the link. The stream ID signal can include a code component, with a value identifying the particular type of the corresponding data, and a parity component based on the code component. The parity component can be used by the receiving device to determine whether the stream ID signal has one or more bit errors. The stream ID signal for the particular data can be sent 1410 to another device concurrently with (or otherwise in association with) the sending 1415 of the particular data to the other device over the link. The particular data can be sent (1415) on dedicated data lanes of the link, while the stream ID signal can be sent on a stream lane of the link. Other data of a different type can be subsequently sent on the same link, with a corresponding stream ID being generated to be sent on the stream lane corresponding with the sending of the other data. The stream ID of the other data can also include a code component and parity component.

Turning to FIG. 14B, a stream ID signal can be received 1435 on a stream lane of a link, the stream ID signal corresponding to particular data of a particular one of a plurality of different data types. The stream ID signal can include a code component identifying that the particular data is of the particular type and a parity component. In some implementations, the stream ID signal can include an example SECDED code similar to the example stream ID codes described above. The particular data can be received 1440 on the data lanes. The parity component of the stream ID signal can be used to determine 1445 an error in the received stream ID signal. The error can be corrected 1450 using values of the parity component. For instance, a corrected/recovered version of the code component can be generated using the parity component (and/or code component). The particular data can be processed 1455 based on the corrected stream ID code. Indeed, data received on data lanes of the physical link may be processed based on its corresponding type as indicated by a corresponding stream ID, among other examples.

Note that the apparatus', methods', and systems described above may be implemented in any electronic device or system as aforementioned. As specific illustrations, the figures below provide exemplary systems for utilizing the invention as described herein. As the systems below are described in more detail, a number of different interconnects are disclosed, described, and revisited from the discussion above. And as is readily apparent, the advances described above may be applied to any of those interconnects, fabrics, or architectures.

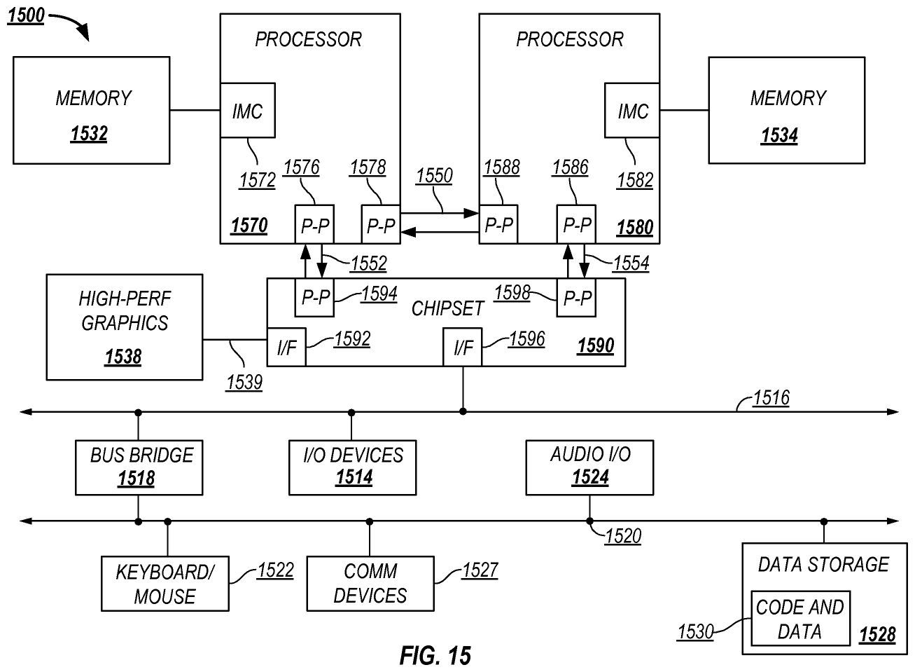

Referring now to FIG. 15, an example implementation of a system 1500 is shown in accordance with an example embodiment. As shown in FIG. 15, multiprocessor system 1500 is a point-to-point interconnect system, and includes a first processor 1570 and a second processor 1580 coupled via a point-to-point interconnect 1550. Each of processors 1570 and 1580 may be some version of a processor. In one embodiment, 1552 and 1554 are part of a serial, point-to-point coherent interconnect fabric, such as a high-performance architecture.

While shown with only two processors 1570, 1580, it is to be understood that the scope of the present invention is not so limited. In other embodiments, one or more additional processors may be present in a given processor.

Processors 1570 and 1580 are shown including integrated memory controller units 1572 and 1582, respectively. Processor 1570 also includes as part of its bus controller units point-to-point (P-P) interfaces 1576 and 1578; similarly, second processor 1580 includes P-P interfaces 1586 and 1588. Processors 1570, 1580 may exchange information via a point-to-point (P-P) interface 1550 using P-P interface circuits 1578, 1588. As shown in FIG. 15, IMCs 1572 and 1582 couple the processors to respective memories, namely a memory 1532 and a memory 1534, which may be portions of main memory locally attached to the respective processors.

Processors 1570, 1580 each exchange information with a chipset 1590 via individual P-P interfaces 1552, 1554 using point to point interface circuits 1576, 1594, 1586, 1598. Chipset 1590 also exchanges information with a high-performance graphics circuit 1538 via an interface circuit 1592 along a high-performance graphics interconnect 1539.

A shared cache (not shown) may be included in either processor or outside of both processors; yet connected with the processors via P-P interconnect, such that either or both processors' local cache information may be stored in the shared cache if a processor is placed into a low power mode.

Chipset 1590 may be coupled to a first bus 1516 via an interface 1596. In one embodiment, first bus 1516 may be a Peripheral Component Interconnect (PCI) bus, or a bus such as a PCI Express bus or another third generation I/O interconnect bus, although the scope of the present invention is not so limited.

As shown in FIG. 15, various I/O devices 1514 are coupled to first bus 1516, along with a bus bridge 1518 which couples first bus 1516 to a second bus 1520. In one embodiment, second bus 1520 includes a low pin count (LPC) bus. Various devices are coupled to second bus 1520 including, for example, a keyboard and/or mouse 1522, communication devices 1527 and a storage unit 1528 such as a disk drive or other mass storage device which often includes instructions/code and data 1530, in one embodiment. Further, an audio I/O 1524 is shown coupled to second bus 1520. Note that other architectures are possible, where the included components and interconnect architectures vary. For example, instead of the point-to-point architecture of FIG. 15, a system may implement a multi-drop bus or other such architecture.

While the present invention has been described with respect to a limited number of embodiments, those skilled in the art will appreciate numerous modifications and variations therefrom. It is intended that the appended claims cover all such modifications and variations as fall within the true spirit and scope of this present invention.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present invention.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the invention may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. One or more embodiments may provide an apparatus, a system, a machine readable storage, a machine readable medium, and/or a method to receive first data on a plurality of data lanes of a physical link, receive second data on at least a portion of the plurality of data lanes, and receive a stream signal, corresponding to the second data, on another of the lanes of the physical link, where the second data is of a second type and the first data is of a different second type, and the stream signal includes a code component indicating that the second data is of the second type and a parity component for use in identifying whether a bit error is present in the stream signal.

In one example, the parity component for use in identifying whether a bit error is present is derived from the code component of the stream signal.

In one example, error detection logic is provided to determine that at least one of the bits of the code component is in error based at least in part on values of the parity component.

In one example, the error detection logic is further to identify a particular one of the bits of the code that is in error.

In one example, error correction logic is provided to autonomously correct the bits of the code component that are determined to be in error.

In one example, correcting the bits of the code component that are determined to be in error includes generating a corrected code component using values of the parity component.

In one example, the stream signal is an 8-bit signal, the code component includes 4 of the 8 bits of the stream signal, and the parity component includes another 4 of the 8 bits of the stream signal.

In one example, the stream signal includes a single error correcting, double error detecting (SECDED)-based code.

In one example, the 8-bit signal corresponds to an 8 unit interval (UI) window for sending data on the physical link.

In one example, a new stream signal is sent at each 8UI window in which corresponding data is sent on the data lanes.

In one example, the stream signal is scrambled and the physical layer logic is further to unscramble the stream signal.

In one example, the first and second data are scrambled and the physical layer logic is further to unscramble the first and second data.

In one example, the code component includes a particular one of a plurality of code values and each data type supported by the physical layer is assigned a respective one of the plurality of code values.

In one example, a Hamming distance of each of the plurality of code values is greater than or equal to HD=4.

In one example, data of the first type is of a first interconnect protocol and data of the second type is of a different second interconnect protocol.

One or more embodiments may provide an apparatus, a system, a machine readable storage, a machine readable medium, and/or a method to send first data on a plurality of data lanes of a physical link to another device, send second data on at least a portion of the plurality of data lanes, and send a stream signal, corresponding to the second data, on another of the lanes of the physical link, where the second data is of a second type and the first data is of a different second type and the stream signal includes a code component indicating that the second data is of the second type and a parity component for use in identifying whether a bit error is present in the stream signal.

In one example, physical layer logic is to scramble the stream signal using a pseudorandom binary sequence and the scrambled stream signal includes the stream signal sent to the other device over the other lane.

In one example, the physical layer logic includes a linear feedback shift register (LFSR) and the pseudorandom binary sequence is generated by the LFSR.

In one example, the other lane includes a stream lane of the link and the physical layer logic is further to assert a valid lane, different from the stream lane and data lanes, to indicate that data is being sent on at least a portion of the data lanes of the physical link.

In one example, the physical link includes a multi-protocol link, and the multi-protocol link is time-multiplexed to send data of a plurality of different protocols on the link.

In one example, parity logic is provided to determine values of the parity component from values of the code component.

One or more embodiments may provide a system including an interconnect including a plurality of lanes, where the plurality of lanes include a plurality of dedicated data lanes, at least one dedicated valid signal lane, and at least one stream signal lane. The system can further include a first device and a second device communicatively coupled to the first device using the interconnect. The second device can include logic to send first data on the data lanes to the first device, send second data on at least a portion of the plurality of data lanes to the first device, where the second data is of a second type and the first data is of a different second type, and send a stream signal, corresponding to the second data, to the first device on another of the lanes of the physical link. The stream signal can include a code component indicating that the second data is of the second type and a parity component for use in identifying whether a bit error is present in the stream signal.

In one example, the first device is to generate a value from the parity component to determine whether a bit error is present in the stream signal.

In one example, the first device is to generate a corrected version of the stream signal based at least in part on values of the parity component.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

1. An apparatus comprising:
physical layer logic to:
receive first data on a plurality of data lanes of a physical link;
receive second data on at least a portion of the plurality of data lanes, wherein the second data is of a second type and the first data is of a different second type; and
receive a stream signal, corresponding to the second data, on another of the lanes of the physical link, wherein the stream signal comprises a code component indicating that the second data is of the second type and a parity component for use in identifying whether a bit error is present in the stream signal.

2. The apparatus of claim 1, wherein the parity component for use in identifying whether a bit error is present is derived from the code component of the stream signal.

3. The apparatus of claim 1, further comprising error detection logic to determine that at least one of the bits of the code component is in error based at least in part on values of the parity component.

4. The apparatus of claim 3, wherein the error detection logic is further to identify a particular one of the bits of the code that is in error.

5. The apparatus of claim 4, further comprising error correction logic to autonomously correct the bits of the code component that are determined to be in error, wherein correcting the bits of the code component that are determined to be in error comprises generating a corrected code component using values of the parity component.

6. (canceled)

7. The apparatus of claim 1, wherein the stream signal is an 8-bit signal, the code component comprises 4 of the 8 bits of the stream signal, and the parity component comprises another 4 of the 8 bits of the stream signal.

8. The apparatus of claim 7, wherein the stream signal comprises a single error correcting, double error detecting (SECDED)-based code.

9. The apparatus of claim 7, wherein the 8-bit signal corresponds to an 8 unit interval (UI) window for sending data on the physical link.

10. The apparatus of claim 9, wherein a new stream signal is sent at each 8UI window in which corresponding data is sent on the data lanes.

11. The apparatus of claim 1, wherein the stream signal is scrambled and the physical layer logic is further to unscramble the stream signal.

12. The apparatus of claim 11, wherein the first and second data are scrambled and the physical layer logic is further to unscramble the first and second data.

13. The apparatus of claim 1, wherein the code component comprises a particular one of a plurality of code values and each data type supported by the physical layer is assigned a respective one of the plurality of code values.

14. The apparatus of claim 13, wherein a Hamming distance of each of the plurality of code values is greater than or equal to HD=4.

15. The apparatus of claim 13, wherein data of the first type is of a first interconnect protocol and data of the second type is of a different second interconnect protocol.

16. An apparatus comprising:
physical layer logic to:
send first data on a plurality of data lanes of a physical link to another device;
send second data on at least a portion of the plurality of data lanes, wherein the second data is of a second type and the first data is of a different second type; and
send a stream signal, corresponding to the second data, on another of the lanes of the physical link, wherein the stream signal comprises a code component indicating that the second data is of the second type and a parity component for use in identifying whether a bit error is present in the stream signal.

17. The apparatus of claim 16, wherein the physical layer logic is to scramble the stream signal using a pseudorandom binary sequence and the scrambled stream signal comprises the stream signal sent to the other device over the other lane.

18. The apparatus of claim 17, wherein the physical layer logic comprises a linear feedback shift register (LFSR) and the pseudorandom binary sequence is generated by the LFSR.

19. The apparatus of claim 16, wherein the other lane comprises a stream lane of the link and the physical layer logic is further to assert a valid lane, different from the stream lane and data lanes, to indicate that data is being sent on at least a portion of the data lanes of the physical link.

20. The apparatus of claim 15, wherein the physical link comprises a multi-protocol link, and the multi-protocol link is time-multiplexed to send data of a plurality of different protocols on the link.

21. The apparatus of claim 16, further comprising parity logic to determine values of the parity component from values of the code component.

22. (canceled)

23. (canceled)

24. (canceled)

25. (canceled)

26. A system comprising:
an interconnect comprising a plurality of lanes, wherein the plurality of lanes include a plurality of dedicated data lanes, at least one dedicated valid signal lane, and at least one stream signal lane;
a first device; and
a second device communicatively coupled to the first device using the interconnect, wherein the second device is to:
send first data on the data lanes to the first device;
send second data on at least a portion of the plurality of data lanes to the first device, wherein the second data is of a second type and the first data is of a different second type; and
send a stream signal, corresponding to the second data, to the first device on another of the lanes of the physical link, wherein the stream signal comprises a code component indicating that the second data is of the second type and a parity component for use in identifying whether a bit error is present in the stream signal.

27. (canceled)

28. (canceled)
